(19) United States
(12) Patent Application Publication
(10) Pub. No.: US 2011/0162723 A1
(43) Pub. Date: Jul. 7, 2011

(54) HYDRAULIC FLUID COMPOSITION THAT REDUCES HYDRAULIC SYSTEM NOISE

(75) Inventors: Douglas G. Placek, Yardley, PA (US); Christian Daniel Georges Neveu, Santeny (FR); Steven Neil Herzog, Glen Mills, PA (US)

(73) Assignee: Evonik Rohmax Additives GMBH, Darmstadt (DE)

(21) Appl. No.: 13/119,567

(22) PCT Filed: Oct. 1, 2009
(86) PCT No.: PCT/EP09/62766

§ 371 Date: Mar. 17, 2011

Related U.S. Application Data
(60) Provisional application No. 61/105,065, filed on Oct. 14, 2008.

(51) Int. Cl. F17D 1/16

(52) U.S. Cl. 137/13

(57) ABSTRACT

Noise generation in a hydraulic system is reduced by contacting a hydraulic fluid comprising a polyalkyl(meth)acrylate polymer with a hydraulic system.

### BACKGROUND OF THE INVENTION

1. Field of the Invention

The present invention describes use of a hydraulic fluid having a VI (viscosity index) of at least 130 that reduces the noise generated by a hydraulic system.

2. Discussion of the Background

Noise is typically the result of vibration generated in a hydraulic system by the pump and/or motor which is amplified through the system and radiated as “airborne noise”. The source of the vibration can be cavitation, fluid flow pressure pulsations, friction, or internal pump leakage. A hydraulic fluid with high viscosity index will radiate a lower level of noise compared to a monograde hydraulic fluid operating at the same temperature and pressure conditions.

Noise generated by hydraulic systems can be a nuisance or potentially dangerous to equipment operators. Machines using fluid power such as mobile construction equipment, agricultural equipment, injection molding machines, and a wide variety of indoor manufacturing equipment are often insulated to protect operators from distracting or harmful noise. The use of shielding increases equipment size, weight, and cost, and also traps heat in the system. In many applications, maximum noise levels are legislated by OSHA or local ordinances to protect workers and the community. As equipment builders have been successful in reducing engine noise, the relative level of hydraulic system noise has increased, and is now a significant contributor to the overall level of noise emitted by a piece of equipment. Hydraulic systems often generate more noise than competitive electric or mechanical power systems.

Overall noise is the sum of both fluid borne noise and structure borne noise. Fluid borne noise is known to be the result of the flow ripple effect of fluid exiting the pump. As each chamber in the pump discharges, fluid flow pulsations are pressure pulsations are generated. This effect is most prominent in piston pumps, but also significant in vane and gear pumps. High frequency flow and pressure pulsations travel to all parts of the circuit and cause component vibration and resonation. Fluid borne vibrations can be converted into airborne noise, and can also have a negative effect on component performance and life.

Additional fluid borne noise can be generated as a result of cavitation, which occurs when entrained air is compressed. Air bubbles can form as entrained, dissolved or dispersed air passes through a low pressure zone, such as the pump inlet. The bubbles are compressed as the fluid enters a high pressure zone on the outlet side of the pump. Shock waves are generated as bubbles in contact with metal surfaces are compressed back into the liquid at ultrasonic speed. The force of fluid filling these voids and slamming into metal surfaces results in very loud banging noise. Air bubble compression is also known to cause physical damage to pump parts as these violent micro forces fear metal from the surface causing pitting and generating abrasive wear debris.

Structure borne noise is the result of fluctuating forces and moments on rotating parts of the pump. As pistons or vanes oscillate between high and low pressure intake/discharge zones, forces are exerted on the swash plate or ring, and external case. Vibration of the hardware results in structure borne noise which is transmitted along a physical path to the tank, mounts and the floor, structure, or vehicle.

Noise can be addressed with “silencers” placed in the system which introduce and superimpose a second sound wave that is at the same amplitude and frequency but at a 180 degree phase angle to the first.

U.S. Pat. No. 6,234,758 describes a hydraulic noise reduction assembly with variable side branch. U.S. Pat. No. 5,560,205 describes a system for attenuation of fluid borne noise.

However, there is a need for a hydraulic fluid that reduces noise in hydraulic systems without the use of silencers or other complicated system modifications.

### BRIEF DESCRIPTION OF DRAWINGS

FIG. 1 shows the dependence of noise on oil viscosity as measured in a Vickers vane pump.

FIG. 2 shows a main pump discharge hose with Parker label in Example 2.

FIG. 3 shows the approximate location of the Parker label and its location with respect to the main pump discharge line in Example 2.

FIG. 4 shows sound levels of an injection molding press in idle.

FIG. 5 shows sound levels of an injection molding press under load.

### DETAILED DESCRIPTION OF THE INVENTION

Hydraulic fluids must provide sufficient viscosity at operating temperatures in order to minimize internal pump recycle or leakage. If hydraulic fluid viscosity drops to an undesirable level, pump efficiency will drop to an unacceptable level. Poor pump efficiency leads to energy consumption level that are higher than necessary.

Viscosity grades are typically used to describe the various categories of fluid viscosity, and are summarized in Table 1.

TABLE 1
Viscosity limits of ISO VG categories described by ISO 3448

| ISO 3448 | Typical | Minimum | Maximum |
|---|---|---|---|
| Viscosity | Viscosity, | Viscosity, | Viscosity, |
| Grades | cSt @ 40° C. | cSt @ 40° C. | cSt @ 40° C. |
| ISO VG 15 | 15.0 | 13.5 | 16.5 |
| ISO VG 22 | 22.0 | 19.8 | 24.2 |
| ISO VG 32 | 32.0 | 28.8 | 35.2 |
| ISO VG 46 | 46.0 | 41.4 | 50.6 |
| ISO VG 68 | 68.0 | 61.2 | 74.8 |
| ISO VG 100 | 100.0 | 90.0 | 110.0 |
| ISO VG 150 | 150.0 | 135.0 | 165.0 |

It is an object of this invention to provide hydraulic fluids that have good low temperature properties. Furthermore, it is desired to produce the hydraulic fluids in a simple and cost effective manner. Additionally, it is an object of the present invention to supply hydraulic fluids being applicable over a wide temperature range. Furthermore, the hydraulic fluid should be appropriate for high pressure applications. Moreover, the hydraulic fluid should reduces noise in hydraulic systems without the use of silencers or other complicated system modifications.

According to the present invention, a method of reducing noise generation in a hydraulic system has been developed which comprises: contacting a hydraulic fluid comprising a polyalkyl(meth)acrylate polymer with a hydraulic system, to reduce the noise of said hydraulic system.

In one embodiment, the hydraulic fluid may contain a base oil, a viscosity index improver and optionally at least one anti-wear additive.

It has been determined that a hydraulic fluid with a viscosity index greater than 130 can be utilized to reduce internal pump leakage/recycle, which also results in the generation of less fluid borne and structure borne noise. The use of a high viscosity index fluid formulated with a poly(meth)acrylate polymer offers several advantages. As published in the RohMax patent application US 2006/0240999, hydraulic fluids containing poly(meth)acrylate polymers entrain less air and offer faster air release time.

In the context of the present invention, internal pump leakage/recycle refers to the following. The purpose of a hydraulic pump is to create a flow of hydraulic fluid that can be used to transfer power from one place to another. Inside a pump there are surfaces (usually metal) that must be lubricated for the pump to operate smoothly. One role of the hydraulic fluid is to lubricate these surfaces while it passes through the pump. To allow this, small pathways (holes) are designed into the internal pump parts so that small amounts of oil can pass through them and onto the surfaces. This flow is called internal leakage or recycle. If the internal leakage or recycle is too great as happens when the fluid becomes very thin, the output (efficiency) of the pump is reduced.

Preferably, PAMA compounds (poly (alkyl (meth)acrylate)) are solubilized as molecular coils that can increase the visco-elasticity of the fluid, and will dampen vibrational waves that are generated as a result of cavitation, fluid flow pulsation ripple effects, and hardware vibration. The type an amount of PAMA may have an influence on the viscosity grade. In one embodiment, the preferred grade is determined by the equipment manufacturers' recommendation.

The act of changing from a standard HM viscosity grade hydraulic fluid to a high viscosity index fluid meeting the Maximum Efficiency Hydraulic Fluid performance definition can result in lower airborne noise levels, and reduced wear from cavitation. The use of such fluids can eliminate the need for silencers and/or insulation, reducing the complexity and cost of a hydraulic system.

At the same time a number of other advantages can be achieved through the hydraulic fluids in accordance with the invention. Among these are:

The hydraulic fluid of the present invention shows an improved low temperature performance and broader temperature operating window.

The hydraulic fluid of the present invention exhibits good resistance to oxidation and is chemically very stable.

The viscosity of the hydraulic fluid of the present invention can be adjusted over a broad range.

Furthermore, the fluids of the present invention are appropriate for high pressure applications. The hydraulic fluids of the present invention show a minimal change in viscosity due to good shear stability.

In the present invention, HM, HV and MEHF hydraulic fluids refer to the following.

HM is an ISO abbreviation for hydraulic oil that is not modified for increased viscosity index. These usually have a viscosity index of approx 95-110 depending on the viscosity index of the base oil being used in the formulation. HV oils have a viscosity index of 130 or greater. These terms are defined by ISO standard 11158. MEHF is a performance definition defined by RohMax that demonstrates a measurable improvement in efficiency due to high viscosity index (>150), excellent shear stability and good low temperature properties of the oil. The concept of MEHF and some of the above terms is further described in detail in “The Benefits Of Maximum Efficientcy Hydraulic Fluids”, in Machinery Lubrication, July-August 2005, at pages 42-48.

In one embodiment of the present invention, noise reduction was obtained using MEHF type fluids.

ISO grade refers to the viscosity of a lubricant as defined by its kinematic viscosity at 40° C. For example, an ISO46 fluid has a kinematic viscosity at 40° C. between 41.4 and 50.6 centistokes. See IS011158.

The hydraulic fluid of the present invention comprises polyalkyl(meth)acrylate polymer. These polymers are obtainable by polymerizing compositions comprising alkyl(meth)acrylate monomers. Preferably, these polyalkyl(meth)acrylate polymers comprise at least 40% by weight, especially at least 50% by weight, more preferably at least 60% by weight and most preferably at least 80% by weight methacrylate repeating units. Preferably, these polyalkyl(meth)acrylate polymers comprise C₉-C₂₄ (meth)acrylate repeating units and C₁-C₈ (meth)acrylate repeating units.

In one embodiment, the polyalkyl(meth)acrylate polymer comprises repeating units derived from dispersing monomers (which include but are not limited to polar monomers, in particular monomers having an N atom in the molecule).

Preferably, the compositions from which the polyalkyl(meth)acrylate polymers are obtainable contain, in particular, (meth)acrylates, maleates and fumarates that have different alcohol residues. The term (meth)acrylate(s) includes methacrylate(s) and acrylate(s) as well as mixtures of the two. These monomers are to a large extent known. The alkyl residue can be linear, cyclic or branched.

Mixtures to obtain preferred polyalkyl(meth)acrylate polymers contain 0 to 100 wt %, preferably 0.5 to 90 wt %, especially 1 to 80 wt %, more preferably 1 to 30 wt %, more preferably 2 to 20 wt % based on the total weight of the monomer mixture of one or more ethylenically unsaturated ester compounds of formula (1)

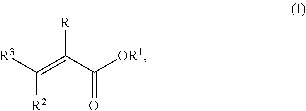

wherein R is hydrogen or methyl, R¹ means a linear or branched alkyl residue with 1-8 carbon atoms, R² and R³ independently represent hydrogen or a group of the formula —COOR′, wherein R′ means hydrogen or a alkyl group with 1-8 carbon atoms.

Examples of component (a) are, among others, (meth)acrylates, fumarates and maleates, which derived from saturated alcohols such as methyl (meth)acryl ate, ethyl (meth)acryl ate, n-propyl (meth)acryl ate, isopropyl(meth)acrylate, n-butyl(meth)acrylate, tert-butyl(meth)acrylate, pentyl(meth)acrylate and hexyl (meth)acrylate, 2-ethyl hexyl(meth)acrylate, heptyl(meth)acrylate, octyl(meth)acrylate; cycloalkyl(meth)acrylates, like cyclopentyl(meth)acrylate, 3-vinylcyclohexy](meth)acrylate, cyclohexyl(meth)acrylate.

Furthermore, the monomer compositions to produce the polyalkyl(meth)acrylates useful in the present invention contain 0-100, preferably 10-99 wt %, especially 20-95 wt % and more preferably 30 to 85 wt % based on the total weight of the monomer mixture of one or more ethylenically unsaturated ester compounds of formula (II)

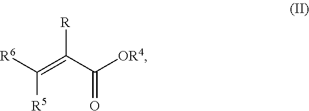

wherein R is hydrogen or methyl, R⁴ means a linear or branched alkyl residue with 9-16 carbon atoms, R⁵ and R⁶ independently are hydrogen or a group of the formula —COOR″, wherein R″ means hydrogen or an alkyl group with 9-16 carbon atoms.

Among these are (meth)acrylates, fumarates and maleates that derive from saturated alcohols, such as 2-tert-butylheptyl(meth)acrylate, 3-isopropylheptyl(meth)acrylate, nonyl(meth)acrylate, decyl(meth)acrylate, undecyl(meth)acrylate, 5-methylundecyl(meth)acrylate, dodecyl(meth)acrylate, 2-methyldodecyl(meth)acrylate, tridecyl(meth)acrylate, 5-methyltridecyl(meth)acrylate, tetradecyl(meth)acrylate, pentadecyl(meth)acrylate, hexadecyl(meth)acrylate; cycloalkyl(meth)acrylates such as bornyl(meth)acrylate; and the corresponding fumarates and maleates.

Furthermore, the monomer compositions to produce the polyalkyl(meth)acrylates useful in the present invention contain 0-80, preferably 0,5-60 wt %, especially 1-40 wt % and more preferably 2 to 30 wt % based on the total weight of the monomer mixture of one or more ethylenically unsaturated ester compounds of formula (III)

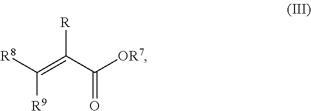

wherein R is hydrogen or methyl, R⁷ means a linear or branched alkyl residue with 17-40 carbon atoms, R⁸ and R⁹ independently are hydrogen or a group of the formula —COOR″′, wherein R″′ means hydrogen or an alkyl group with 17-40 carbon atoms.

Among these are (meth)acrylates, fumarates and maleates that derive from saturated alcohols, such as 2-methylhexadecyl(meth)acrylate, heptadecyl(meth)acrylate, 5-isopropylheptadecyl(meth)acrylate, 4-tert-butyloctadecyl(meth)acrylate, 5-ethyloctadecyl(meth)acrylate, 3-isopropyloctadecyl(meth)acrylate, octadecyl(meth)acrylate, nonadecyl(meth)acrylate, eicosyl(meth)acrylate, cetyleicosyl(meth)acrylate, stearyleicosyl(meth)acrylate, docosyl(meth)acrylate, and/or eicosyltetratriacontyl(meth)acrylate; cycloalkyl(meth)acrylates such as 2,4,5-tri-t-butyl-3-vinylcyclohexyl(meth)acrylate, 2,3,4,5-tetra-t-butylcyclohexyl(meth)acrylate.

The ester compounds with a long-chain alcohol residue, especially components (b) and (c), can be obtained, for example, by reacting (meth)acrylates fumarates, maleates and/or the corresponding acids with long chain fatty alcohols, where in general a mixture of esters such as (meth)acrylates with different long chain alcohol residues results.

These fatty alcohols include, among others, Oxo Alcohol® 7911 and Oxo Alcohol® 7900, Oxo Alcohol® 1100; Alfol® 610 and Alfol® 810; Lial® 125 and Nafol®-Types (Sasol Olefins & Surfactant GmbH); Alphanol® 79 (ICI);Epal® 610 and Epal®) 810 (Ethyl Corporation); Linevol® 79, Linevol® 911 and Neodol® 25E (Shell AG); Dehydad®-, Hydrenol- and Lorol®-Types (Cognis); Acropol® 35 and Exxal® 10 (Exxon Chemicals GmbH); Kalcol® 2465 (Kao Chemicals). Of the ethylenically unsaturated ester compounds, the (meth)acrylates are particularly preferred over the maleates and furmarates, i.e., R², R³, R³, R⁶ , R⁸ and R⁹ of formulas (I) (II) and (III) represent hydrogen in particularly preferred embodiments.

Component (d) comprises in particular ethylenically unsaturated monomers that can copolymerize with the ethylenically unsaturated ester compounds of formula (I) (II) and/or (III).

Comonomers that correspond to the following formula are especially suitable for polymerization in accordance with the invention:

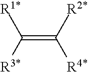

wherein R¹ and R² independently are selected from the group consisting of hydrogen, halogens, CN, linear or branched alkyl groups with 1-20, preferably 1-6 and especially preferably 1-4 carbon atoms, which can be substituted with 1 to (2n+1) halogen atoms, wherein n is the number of carbon atoms of the alkyl group (for example CF₃), α, β-unsaturated linear or branched alkenyl or alkynyl groups with 2-10, preferably 2-6 and especially preferably 2-4 carbon atoms, which can be substituted with 1 to (2n+1) halogen atoms, preferably chlorine, wherein n is the number of carbon atoms of the alkyl group, for example CH₂=CCl—, cycloalkyl groups with 3-8 carbon atoms, which can be substituted with 1 to (2n−1) halogen atoms, preferably chlorine, wherein n is the number of carbon atoms of the cycloalkyl group; C(=Y*)R^{5*}, C(=Y*)NR^{6*}R^{7*}, Y*C(=Y*)R^{5*}, SOR^{5*}, SO₂R^{5*}, OSO₂R^{5*}, NR^{8*}SO₂R^{5*}, PR^{5*}₂, P(=Y*)R^{5*}₂, Y*PR^{5*}₂, Y*P(=Y*)R⁵₂, NR^{8*}₂, which can be quaternized with an additional R^{8*}, aryl, or heterocyclyl group, wherein Y* can be NR^{8*}, S or O, preferably O; R^{5*} is an alkyl group with 1-20 carbon atoms, an alkylthio group with 1-20 carbon atoms, OR¹5 (R¹5 is hydrogen or an alkali metal), alkoxy with 1-20 carbon atoms, aryloxy or heterocyclyloxy; R^{6*} and R^{7*} independently are hydrogen or an alkyl group with one to 20 carbon atoms, or R^{6*} and R^{7*} together can form an alkylene group with 2-7, preferably 2-5 carbon atoms, wherein they form a 3-8 member, preferably 3-6 member ring, and R^{8*} is linear or branched alkyl or aryl groups with 1-20 carbon atoms;

R^{3*} and R^{4*} independently are chosen from the group consisting of hydrogen, halogen (preferably fluorine or chlorine), alkyl groups with 1-6 carbon atoms and COOR^{9*}, wherein R^{9*} is hydrogen, an alkali metal or an alkyl group with 1-40 carbon atoms, or R^{1*} and R^{3*} can together form a group of the formula (CH₂)ₙ, which can be substituted with 1-2n′ halogen atoms or C₁-C₄ alkyl groups, or can form a group of the formula C(=O)−Y*−C(=O), wherein n is from 2-6, preferably 3 or 4, and Y* is defined as before; and wherein at least 2 of the residues R^{1*}, R^{2*}, R^{3*} and R^{4*} are hydrogen or halogen.

These include, among others, hydroxyalkyl(meth)acrylates like 3-hydroxypropyl(meth)acrylate, 3,4-dihydroxybutyl(meth)acrylate, 2-hydroxyethyl(meth)acrylate, 2-hydroxypropyl(meth)acrylate, 2,5-dimethyl-1,6-hexanediol(meth)acrylate, 1,10-decanediol(meth)acrylate;

aminoalkyl(meth)acrylates and aminoalkyl(meth)acrylamides like N-(3-dimethylaminopropyl)methacrylamide, 3-diethylaminopentyl(meth)acrylate, 3-dibutylaminohexadecyl(meth)acrylate;
nitriles of (meth)acrylic acid and other nitrogen-containing (meth)acrylates like N-(methacryloyloxyethyl)diisobutylketimine, N-(methacryloyloxyethyl)dihexadecylketimine, (meth)acryloylamidoacetonitrile, 2-methacryloyloxyethylmethylcyanamide, cyanomethyl(meth)acrylate;
aryl(meth)acrylates like benzyl(meth)acrylate or phenyl(meth)acrylate, wherein the acryl residue in each case can be unsubstituted or substituted up to four times;
carbonyl-containing (meth)acrylates like
2-carboxyethyl(meth)acrylate, carboxymethyl(meth)acrylate,
oxazolidinylethyl(meth)acrylate, N-methyacryloyloxy)formamide,
acetonyl(meth)acrylate, N-methacryloylmorpholine,
N-methacryloyl-2-pyrrolidinone, N-(2-methyacryloxyoxyethyl)-2-pyrrolidinone, N-(3-methacryloyloxypropyl)-2-pyrrolidinone, N-(2-methyacryloyloxypentadecyl (—2-pyrrolidinone, N-(3-methacryloyloxyheptadecyl-2-pyrrolidinone;
(meth)acrylates of ether alcohols like tetrahydrofurfuryl(meth)acrylate, vinyloxyethoxyethyl(meth)acrylate, methoxyethoxyethyl(meth)acrylate, 1-butoxypropyl(meth)acrylate, 1-methyl-(2-vinyloxy)ethyl(meth)acrylate, cyclohexyloxymethyl(meth)acrylate, methoxymethoxyethyl(meth)acrylate, benzyloxymethyl(meth)acrylate, furfuryl(meth)acrylate, 2-butoxyethyl(meth)acrylate, 2-ethoxyethoxymethyl(meth)acrylate, 2-ethoxyethyl(meth)acrylate, ethoxylated(meth)acrylates, allyloxymethyl(meth)acrylate, 1-ethoxybutyl(meth)acrylate, methoxymethyl(meth)acrylate, 1-ethoxyethyl(meth)acrylate, ethoxymethyl(meth)acrylate; (meth)acrylates of halogenated alcohols like 2,3-dibromopropyl(meth)acrylate, 4-bromophenyl(meth)acrylate, 1,3-dichloro-2-propyl(meth)acrylate, 2-bromoethyl(meth)acrylate, 2-iodoethyl(meth)acrylate, chloromethyl(meth)acrylate;
oxiranyl(meth)acrylate like 2,3-epoxybutyl(meth)acrylate, 3,4-epoxybutyl(meth)acrylate, 10,11 epoxyundecyl(meth)acrylate, 2,3-epoxycyclohexyl(meth)acrylate, oxiranyl(meth)acrylates such as 10,11-epoxyhexadecyl(meth)acrylate, glycidyl(meth)acrylate;
phosphorus-, boron- and/or silicon-containing (meth)acrylates like 2-(dimethylphosphato)propyl(meth)acrylate, 2-(ethylphosphito)propyl(meth)acrylate, 2-dimethylphosphinomethyl(meth)acrylate, dimethylphosphonoethyl(meth)acrylate, diethylmethacryloyl phosphonate, dipropylmethacryloyl phosphate, 2-(dibutylphosphono)ethyl(meth)acrylate, 2,3-butylenemethacryloylethyl borate, methyldiethoxymethacryloylethoxysiliane, diethylphosphatoethyl(meth)acrylate;
sulfur-containing (meth)acrylates like ethylsulfinylethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, bis(methacryloyloxyethyl)sulfide;
heterocyclic(meth)acrylates like 2-(1-imidazolyl)ethyl(meth)acrylate, 2-(4morpholinyl)ethyl(meth)acrylate and 1-(2-methacryloyloxyethyl)-2-pyrrolidone;
vinyl halides such as, for example, vinyl chloride, vinyl fluoride, vinylidene chloride and vinylidene fluoride;
vinyl esters like vinyl acetate;
vinyl monomers containing aromatic groups like styrene, substituted styrenes with an alkyl substituent in the side chain, such as α-methylstyrene and α-ethylstyrene, substituted styrenes with an alkyl substituent on the ring such as vinyltoluene and p-methylstyrene, halogenated styrenes such as monochlorostyrenes, dichlorostyrenes, tribromostyrenes and tetrabromostyrenes;
heterocyclic vinyl compounds like 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;
vinyl and isoprenyl ethers;
maleic acid derivatives such as maleic anhydride, methylmaleic anhydride, maleinimide, methylmaleinimide;
fumaric acid and fumaric acid derivatives such as, for example, mono- and diesters of fumaric acid.

Monomers that have dispersing hydraulicity can also be used as comonomers. These monomers are well known in the art and contain usually hetero atoms such as oxygen and/or nitrogen. For example the previously mentioned hydroxyalkyl(meth)acrylates, aminoalkyl(meth)acrylates and aminoalkyl(meth)acrylamides, (meth)acrylates of ether alcohols, heterocyclic(meth)acrylates and heterocyclic vinyl compounds are considered as dispersing comononers.

Especially preferred mixtures contain methyl methacrylate, lauryl methacrylate and/or stearyl methacrylate.

The components can be used individually or as mixtures.

The molecular weight of the alkyl(meth)acrylate polymers is not critical. Usually the alkyl(meth)acrylate polymers have a molecular weight in the range of 300 to 1,000,000 g/mol, preferably in the range of range of 10000 to 200,000 g/mol and especially preferably in the range of 25000 to 100,000 g/mol, without any limitation intended by this. These values refer to the weight average molecular weight of the polydisperse polymers.

Without intending any limitation by this, the alkyl(meth)acrylate polymers exhibit a polydispersity, given by the ratio of the weight average molecular weight to the number average molecular weight M_{w}/Mₙ, in the range of 1 to 15, preferably 1.1 to 10, especially preferably 1.2 to 5.

The monomer mixtures described above can be polymerized by any known method. Conventional radical initiators can be used to perform a classic radical polymerization. These initiators are well known in the art. Examples for these radical initiators are azo initiators like 2,2′-azodiisobutyronitrile (AIBN), 2,2′-azobis(2-methylbutyronitrile) and 1,1-azobiscyclohexane carbonitrile; peroxide compounds, e.g. methyl ethyl ketone peroxide, acetyl acetone peroxide, dilauryl peroxide, tert.-butyl per-2-ethyl hexanoate, ketone peroxide, methyl isobutyl ketone peroxide, cyclohexanone peroxide, dibenzoyl peroxide, tert.-butyl perbenzoate, tert.-butyl peroxy isopropyl carbonate, 2,5-bis(2-ethylhexanoyl-peroxy)-2,5-dimethyl hexane, tert.-butyl peroxy 2-ethyl hexanoate, tert.-butyl peroxy- 3,5,5-trimethyl hexanoate, dicumene peroxide, 1,1-bis(tert.-butyl peroxy) cyclohexane, 1,1 -bis(tert.-butyl peroxy) 3,3,5-trimethyl cyclohexane, cumene hydroperoxide and tert.-butyl hydroperoxide.

Low molecular weight poly(meth)acrylates can be obtained by using chain transfer agents. This technology is ubiquitously known and practiced in the polymer industry and is described in Odian, Principles of Polymerization, 1991. Examples of chain transfer agents are sulfur containing compounds such as thiols, e.g. n- and t-dodecanethiol, 2-metcaptoethanol, and mercapto carboxylic acid esters, e.g. methyl-3-mercaptopropionate. Preferred chain transfer agents contain up to 20, especially up to 15 and more preferably up to 12 carbon atoms.

Furthermore, chain transfer agents may contain at least 1, especially at least 2 oxygen atoms.

Furthermore, the low molecular weight poly(meth)acrylates can be obtained by using transition metal complexes, such as low spin cobalt complexes. These technologies are well known and for example described in USSR patent 940,487-A and by Heuts, et al., Macromolecules 1999, pp 2511-2519 and 3907-3912.

Furthermore, novel polymerization techniques such as ATRP (Atom Transfer Radical Polymerization) and or RAFT (Reversible Addition Fragmentation Chain Transfer) can be applied to obtain useful poly(meth)acrylates. These methods are well known. The ATRP reaction method is described, for example, by J-S. Wang, et al., J. Am. Chem. Soc., Vol. 117, pp. 5614-5615 (1995), and by Matyjaszewski, Macromolecules, Vol. 28, pp. 7901-7910 (1995). Moreover, the patent applications WO 96/30421, WO 97/47661, WO 97/18247, WO 98/40415 and WO 99/10387 disclose variations of the ATRP explained above to which reference is expressly made for purposes of the disclosure. The RAFT method is extensively presented in WO 98/01478, for example, to which reference is expressly made for purposes of the disclosure.

The polymerization can be carried out at normal pressure, reduced pressure or elevated pressure. The polymerization temperature is also not critical. However, in general it lies in the range of −20-200° C., preferably 0-130° C. and especially preferably 60-120° C., without any limitation intended by this.

The polymerization can be carried out with or without solvents. The term solvent is to be broadly understood here.

The hydraulic fluid may comprise 0.5 to 50% by weight, especially 1 to 30% by weight, and preferably 5 to 20% by weight, based on the total weight of the hydraulic fluid, of one or more polyalkyl(meth)acrylate polymers.

The hydraulic fluid of the present invention may comprise a base stock. These base stocks may comprise a mineral oil and/or a synthetic oil.

Mineral oils are substantially known and commercially available. They are in general obtained from petroleum or crude oil by distillation and/or refining and optionally additional purification and processing methods, especially the higher-boiling fractions of crude oil or petroleum fall under the concept of mineral oil. In general, the boiling point of the mineral oil is higher than 200° C., preferably higher man 300° C., at 5000 Pa. Preparation by low temperature distillation of shale oil, coking of hard coal, distillation of lignite under exclusion of air as well as hydrogenation of hard coal or lignite is likewise possible. To a small extent mineral oils are also produced from raw materials of plant origin (for example jojoba, rapeseed (canola), sunflower, soybean oil) or animal origin (for example tallow or neats foot oil). Accordingly, mineral oils exhibit different amounts of aromatic, cyclic, branched and linear hydrocarbons, in each case according to origin.

In general, one distinguishes paraffin-base, naphthenic and aromatic fractions in crude oil or mineral oil, where the term paraffin-base fraction stands for longer chain or highly branched isoalkanes and naphthenic fraction stands for cycloalkanes. Moreover, mineral oils, in each case according to origin and processing, exhibit different fractions of n-alkanes, isoalkanes with a low degree of branching, so called monomethyl-branched paraffins, and compounds with heteroatoms, especially O, N and/or S, to which polar properties are attributed. However, attribution is difficult, since individual alkane molecules can have both long-chain branched and cycloalkane residues and aromatic components. For purposes of this invention, classification can be done in accordance with DIN 51 378. Polar components can also be determined in accordance with ASTM D 2007.

The fraction of n-alkanes in the preferred mineral oils is less than 3 wt %, and the fraction of O, N and/or S-containing compounds is less than 6 wt %. The fraction of aromatic compounds and monomethyl-branched paraffins is in general in each case in the range of 0-40 wt %. In accordance with one interesting aspect, mineral oil comprises mainly naphthenic and paraffin-base alkanes, which in general have more than 13, preferably more than 18 and especially preferably more than 20 carbon atoms. The fraction of these compounds is in general at least 60 wt %, preferably at least 80 w %, without any limitation intended by this. A preferred mineral oil contains 0.5-30 wt % aromatic components, 15-40 wt % naphthenic components, 35-80 wt % paraffin-base components, up to 3 wt % n-alkanes and 0.05-5 wt % polar components, in each case with respect to the total weight of the mineral oil.

An analysis of especially preferred mineral oils, which was done with traditional methods such as urea dewaxing and liquid chromatography on silica gel, shows, for example, the following components, where the percentages refer to the total weight of the relevant mineral oil:

n-alkanes with about 18-31 C atoms: 0.7-1.0%,

low-branched alkanes with 18-31 C atoms: 1.0-8.0%,

aromatic compounds with 14-32 C atoms: 0.4-10.7%,

iso- and cycloalkanes with 20-32 C atoms: 60.7-82.4%,

polar compounds: 0.1-0.8%,

loss: 6.9-19.4%.

Valuable advice regarding the analysis of mineral oil as well as a list of mineral oils that have other compositions can be found, for example, in Ullmann's Encyclopedia of Industrial Chemistry, 5^{th} Edition on CD-ROM, 1997, under the entry “lubricants and related products.”

Preferably, the hydraulic fluid is based on mineral oil from API Group I, II, or III. API publication 1509 provides a reference regarding the American Petroleum Institute (API) definition of these groups. The API 1509 publication is incorporated herein by reference in its entirety.

Synthetic oils are, among other substances, organic esters like carboxylic esters and phosphate esters; organic ethers like silicone oils and polyalkylene glycol; and synthetic hydrocarbons, especially polyolefins. They are for the most part somewhat more expensive than the mineral oils, but they have advantages with regard to performance. For an explanation one should refer to the 5 API classes of base oil types (API: American Petroleum Institute).

Phosphorus ester fluids such as alkyl aryl phosphate ester; trialkyl phosphates such as tributyl phosphate or tri-2-ethylhexyl phosphate; triaryl phosphates such as mixed isopropylphenyl phosphates, mixed t-butylphenyl phosphates, trixylenyl phosphate, or tricresylphosphate. Additional classes of organophosphorus compounds are phosphonates and phosphinates, which may contain alkyl and/or aryl substituents. Dialkyl phosphonates such as di-2-elhylhexylphosphonate; alkyl phosphinates such as di-2-elhylhexylphosphinate are possible. As the alkyl group herein, linear or branched chain alkyls consisting of 1 to 10 carbon atoms are preferred. As the aryl group herein, aryls consisting of 6 to 10 carbon atoms that maybe substituted by alkyls are preferred. Usually the hydraulic fluids contain 0 to 60% by weight, preferably 5 to 50% by weight organophosphorus compounds.

As the carboxylic acid esters reaction products of alcohols such as polyhydric alcohol, monohydric alcohol and the like, and fatty acids such as mono carboxylic acid, poly carboxylic acid and the like can be used. Such carboxylic acid esters can of course be a partial ester.

Carboxylic acid esters may have one carboxylic ester group having the formula R-COO-R, wherein R is independently a group comprising 1 to 40 carbon atoms. Preferred ester compounds comprise at least two ester groups. These compounds may be based on poly carboxylic acids having at least two acidic groups and/or polyols having at least two hydroxyl groups.

The poly carboxylic acid residue usually has 2 to 40, preferably 4 to 24, especially 4 to 12 carbon atoms. Useful polycarboxylic acids esters are, e.g., esters of adipic, azelaic, sebacic, phthalate and/or dodecanoic acids. The alcohol component of the polycarboxylic acid compound preferably comprises 1 to 20, especially 2 to 10 carbon atoms.

Examples of useful alcohols are methanol, ethanol, propanol, butanol, pentanol, hexanol, heptanol and octanol. Furthermore, oxoalcohols can be used such as diethylene glycol, triethylene glycol, tetraethylene glycol up to decamethylene glycol.

Especially preferred compounds are esters of polycarboxylic acids with alcohols comprising one hydroxyl group. Examples of these compounds are described in Ullmans Encyclopadie der Technischen Chemie, third edition, vol. 15, page 287-292, Urban & Schwarzenber (1964)).

According to another aspect of the present invention, the hydraulic fluid is based on a synthetic basestock comprising poly-alpha olefin (PAO), carboxylic esters (diester, or polyol ester), phosphate ester (trialkyl, triaryl, or alkyl aryl phosphates), and/or polyalkylene glycol (PAG).

The hydraulic fluid of the present invention may comprise further additives well known in the art such as viscosity index improvers, antioxidants, anti-wear agents, corrosion inhibitors, detergents, dispersants, EP additives, defoamers, friction reducing agents, pour point depressants, dyes, odorants and/or demulsifiers. These additives are used in conventional amounts. Usually the hydraulic fluids contain 0 to 10% by weight additives.

According to the consumer needs, the viscosity of the hydraulic fluid of the present invention can be adapted with in wide range. ISO VG 15, VG 22, VG 32, VG 46, VG 68, VG 100, VG 150, VG 1500 and VG 3200 fluid grades can be achieved, e.g.

| ISO 3448 or | Typical | Minimum | Maximum |
|---|---|---|---|
| ASTM 2422 | Viscosity, | Viscosity, | Viscosity, |
| Viscosity Grades | cSt @ 40° C. | cSt @ 40° C. | cSt @ 40° C. |
| ISO VG 15 | 15.0 | 13.5 | 16.5 |
| ISO VG 22 | 22.0 | 19.8 | 24.2 |
| ISO VG 32 | 32.0 | 28.8 | 35.2 |
| ISO VG 46 | 46.0 | 41.4 | 50.6 |
| ISO VG 68 | 68.0 | 61.2 | 74.8 |
| ISO VG 100 | 100.0 | 90.0 | 110.0 |
| ISO VG 150 | 150.0 | 135.0 | 165.0 |
| ISO VG 1500 | 1500.0 | 1350.0 | 1650.0 |
| ISO VG 3200 | 3200.0 | 2880.0 | 3520.0 |

The viscosity grades as mentioned above can be considered as prescribed ISO viscosity grade. Preferably, the ISO viscosity grade is in the range of 15 to 3200, more preferably 22 to 150.

According to a further aspect of the invention the preferred ISO viscosity grade is in the range of 150 to 3200, more preferably 1500 to 3200.

In order to achieve a prescribed ISO viscosity grade, preferably a base stock having a low viscosity grade is mixed with the polyalkyl(meth)acrylate polymer.

Preferably the kinematic viscosity 40° C. according to ASTM D 445 of is the range of 15 mm²/s to 150 mm²/s, preferably 28 mm²/s to 110 mm²/s. The hydraulic fluid of the present invention has a high viscosity index. Preferably the viscosity index according to ASTM D 2270 is at least 120, more preferably 150, especially at least 180 and more preferably at least 200.

The hydraulic fluid of the present invention has good low temperature performance. The low temperature performance can be evaluated by the Brookfield viscosimeter according to ASTM D 2983.

The hydraulic fluid of the present invention can be used for high pressure applications. Preferred embodiments can be used at pressures between 0 to 700 bar, and specifically between 70 and 400 bar.

Furthermore, preferred hydraulic fluids of the present invention have a low pour point, which can be determined, for example, in accordance with ASTM D 97. Preferred fluids have a pour point of −30° C. or less, especially −40° C. or less and more preferably −45° C. or less.

The hydraulic fluid of the present invention can be used over a wide temperature range. For example the fluid can be used in a temperature operating window of −40° C. to 120° C., and meet the equipment manufactures requirements for minimum and maximum viscosity. A summary of major equipment manufacturers viscosity guidelines can be found in National Fluid Power Association recommended practice T2.13.13-2002.

The hydraulic fluids of the present invention are useful e.g. in industrial, automotive, mining, power generation, marine and military hydraulic fluid applications. Mobile equipment applications include construction, forestry, delivery vehicles and municipal fleets (trash collection, snow plows, etc.). Marine applications include ship deck cranes.

The hydraulic fluids of the present invention are useful in power generation hydraulic equipment such as electrohydraulic turbine control systems.

Furthermore, the hydraulic fluids of the present invention are useful as transformer liquids or quench oils.

Having generally described this invention, a further understanding can be obtained by reference to certain specific examples which are provided herein for purposes of illustration only, and are not intended to be limiting unless otherwise specified.

### EXAMPLES

### Example 1

The noise versus oil viscosity in a Vickers vane pump was measured as follows. The vane pump (Vickers V20 pump) was operated under the following conditions: 1. The initial oil was at room temperature prior to the start of the test. 2. The discharge pressure was constant (three different pressures tested) with no oil cooling. 3. Pressure, flow, time and temperatures were recorded.

A SPER Scientific Sound Meter 840029 from SPER was used to record sound levels (in dB). A reading was taken every 5 minutes near the motor-pump shaft once the vane pump was operating.

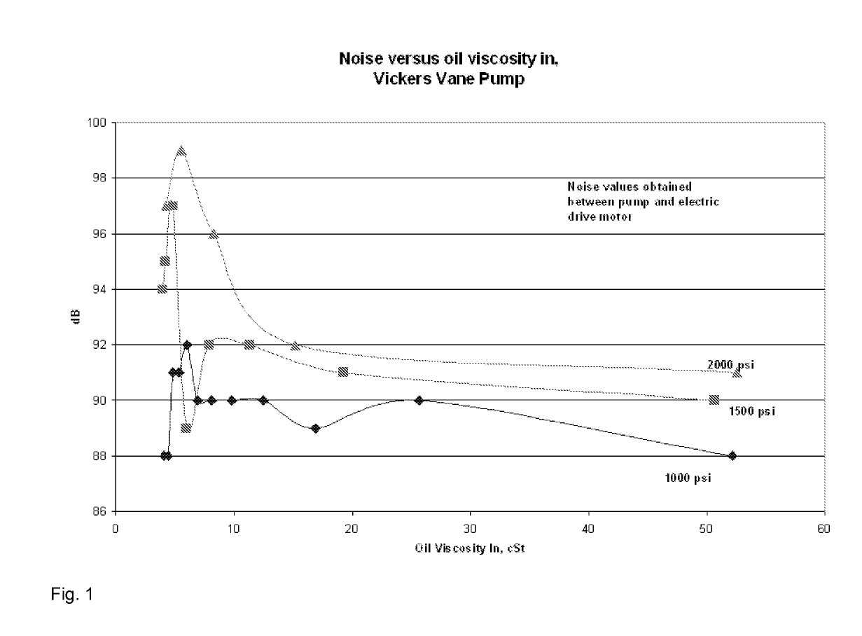

FIG. 1 shows the results of the measurements for 1000 Psi (♦), 1500 psi (▪) and 2000 psi (▴).

FIG. 1 shows a comparison of ISO 22 HM hydraulic fluid in the Vickers V20 pump. measurements made with a hand-held OSHA noise monitor between the pump and the electric motor drive. There is a clear indication that external noise decreases at all pressures as viscosity increases.

### Example 2

Experiments run on a full-scale injection molding press showing that when the press was operating (a.k.a. under load) using the high VI oil, it produced significantly less noise then when the press was operating using the standard (monograde) oil.

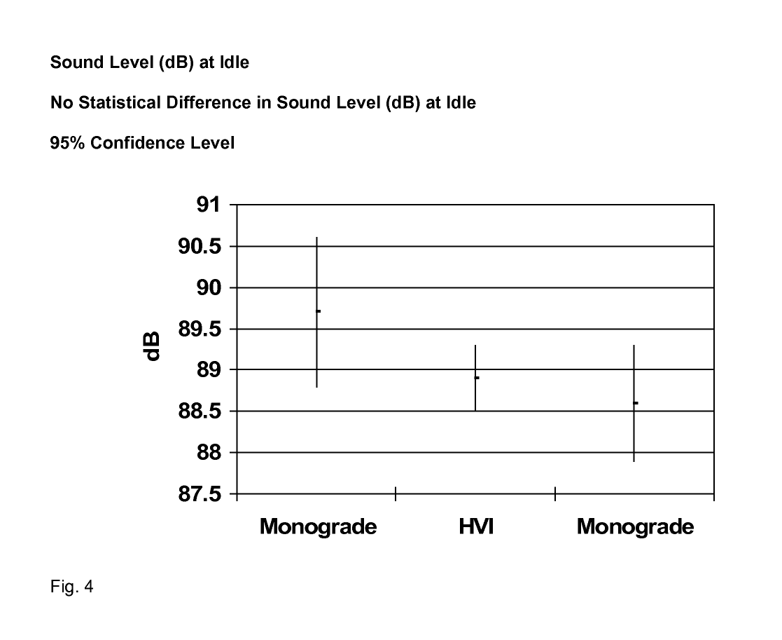

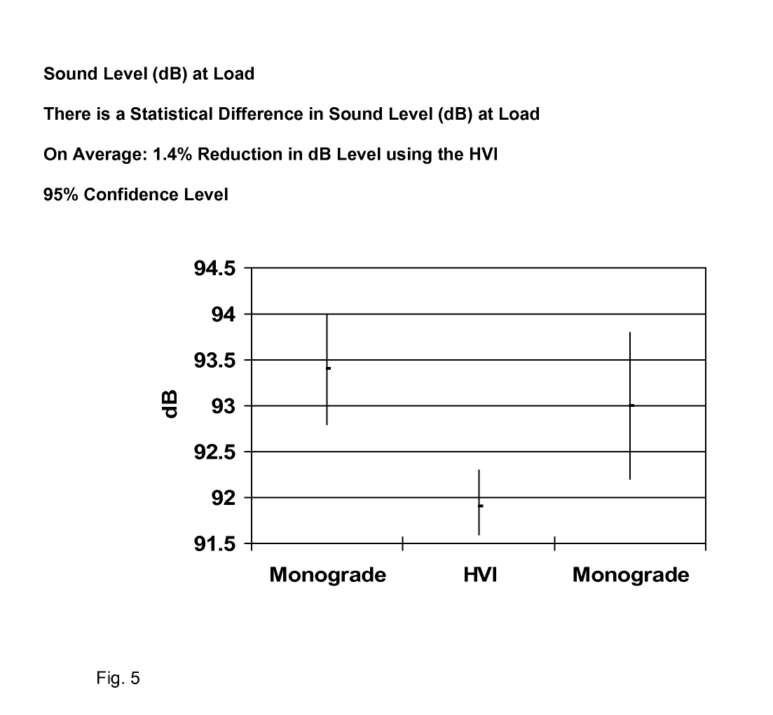

See also FIGS. 4 and 5.

Measurement of Sound Levels from a Vane Pump using a Monograde and High VI Multigrade Hydraulic Fluid

A Van Doron 55 injection molding machine (IMM) located at MSI in Bessemer City, North Carolina was used to evaluate the hydraulic fluids. The monograde fluid tested was Mobil DTE 25 (DTE) and the multigrade fluid tested was Rohmax High VI hydraulic fluid (HVI). Before (at start of test) and after (at end of test) viscosity results of the hydraulic fluids are in the following table.

| Oil | Condition | 40° C. (cSt) | 100° C. (cSt) | VI |
|---|---|---|---|---|
| DTE | Before | 45.28 | 6.718 | 101 |
| DTE | After | 45.28 | 6.716 | 101 |
| HVI | Before | 48.39 | 10.26 | 207 |
| HVI | After | 47.93 | 10.13 | 206 |
| DTE | Before | 44.86 | 6.710 | 102 |
| DTE | After | 44.77 | 6.729 | 103 |

All operating changes to the IMM were performed by MSI personnel and were based on IMM part quality.

To record the sound level, the following equipment was used under the following conditions:

Sper Scientific Sound Meter 840029

Power on (DC)

Weighting C

dB 50 -100

Response fast.

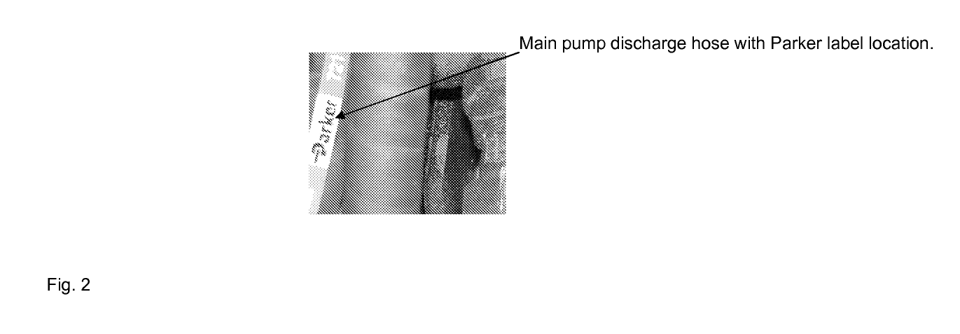

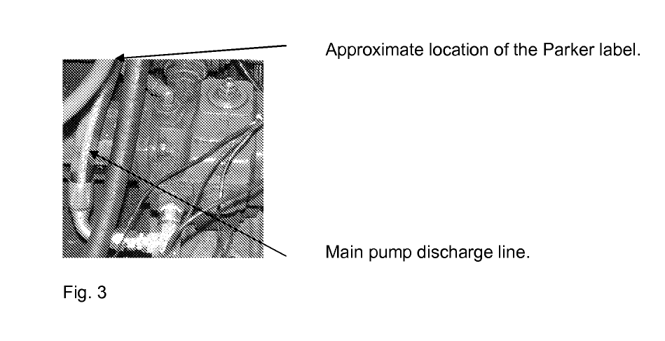

Because of the complexity of the IMM, sound levels were recorded off the main pump discharge hose at the Parker label. The meter was held approximately 1″ from the main pump discharge hose. The highest sound level was recorded at random times during the day at both the IMM idle and load stages. The FIGS. 2 and 3 show the location of the label and the labels approximate location to the main pump discharge hose. This location was used throughout the sound measurement data collection.

The data was transferred to an Excel spreadsheet and a single factor ANOVA was performed on the data to determine if there is a difference in the null hypothesis (is there a difference in the population means). The null hypothesis is rejected if F>F(critical) (yes there is a difference in means). The data was analyzed and the following table was constructed:

| Hypothesis | Pump | F | F(critical) | Difference |
|---|---|---|---|---|
| DTE = HVI = DTE | At Idle | 2.42 | 3.23 | No |
| DTE = HVI = DTE | At Load | 5.48 | 3.23 | Yes |
| DTE = HVI | At Load | 13.87 | 4.21 | Yes |
| HVI = DTE | At Load | 5.37 | 4.23 | Yes |
| DTE = HVI = DTE | At Load | 9.03 | 3.23 | Yes |
| (Load − Idle) | | | | |
| DTE = HVI | At Load | 4.07 | 4.21 | No |
| (Load − Idle) | | | | |
| HVI = DTE | At Load | 19.47 | 4.23 | Yes |
| (Load − Idle) | | | | |
| DTE = DTE | At Load | 0.61 | 4.21 | No |

95% confidence Interval for the dB observed were calculated in Excel and are presented for each hypothesis.

| | | |
|---|---|---|
| dB (avg) | dB (high) | dB (low) |

DTE = HVI = DTE at pump idle.

| | | | |
|---|---|---|---|
| DTE | 89.7 | 90.6 | 88.8 |
| HVI | 88.9 | 90.3 | 88.5 |
| DTE | 88.6 | 89.3 | 87.9 |

DTE = HVI = DTE at pump load.

| | | | |
|---|---|---|---|
| DTE | 93.4 | 94.0 | 92.8 |
| HVI | 91.9 | 92.3 | 91.5 |
| DTE | 93.0 | 93.8 | 92.2 |

DTE = HVI at pump load.

| | | | |
|---|---|---|---|
| DTE | 93.4 | 94.0 | 92.8 |
| HVI | 91.9 | 92.3 | 91.5 |

HVI = DTE at pump load.

| | | | |
|---|---|---|---|
| HVI | 91.9 | 92.3 | 91.5 |
| DTE | 93.0 | 93.8 | 92.2 |

DTE = HVI = DTE load minus idle.

| | | | |
|---|---|---|---|
| DTE | 3.7 | 4.2 | 3.2 |
| HVI | 3.0 | 3.5 | 2.5 |
| DTE | 4.4 | 4.8 | 4.0 |

DTE = HVI = DTE load minus idle.

| | | | |
|---|---|---|---|
| DTE | 3.7 | 4.2 | 3.2 |
| HVI | 3.0 | 3.5 | 2.5 |
| DTE | 4.4 | 4.8 | 4.0 |

DTE = HVI = DTE load minus idle.

| | | | |
|---|---|---|---|
| DTE | 3.7 | 4.2 | 3.2 |
| HVI | 3.0 | 3.5 | 2.5 |
| DTE | 4.4 | 4.8 | 4.0 |

DTE = HVI load minus idle.

| | | | |
|---|---|---|---|
| DTE | 3.7 | 4.2 | 3.2 |
| HVI | 3.0 | 3.5 | 2.5 |

HVI = DTE load minus idle.

| | | | |
|---|---|---|---|
| HVI | 3.0 | 3.5 | 2.5 |
| DTE | 4.4 | 4.8 | 4.0 |

DTE = DTE at pump load.

| | | | |
|---|---|---|---|
| DTE | 93.4 | 94.0 | 92.8 |
| DTE | 93.0 | 93.8 | 92.2 |

General observations regarding the sound measurement study.

1. The Variable Volume pump Rexroth Model V-4 appears to have some type of ‘sound level tuning adjustment’ on its main body. No adjustment was made to this device during the sound test.

2. HVI oil appears to dampen the noise (frequency, tone) enough so that the HVI is not as annoying as the DTE oil (subjective observation of the person performing the experiment).

3. Sound levels appear to be higher at the high pressure rubber discharge hose than by the main pump.

4. Sound reading at Parker label with the IMM off was 72 dB's (other equipment was in operation).

### Summary of Example 2

1. At pump idle, there is no statistical difference in the sound level (dB) produced between a Monograde and High VI Multigrade hydraulic fluid.

2. Under pump load, there is a statistical difference in the sound level (dB) produced between a Monograde and High VI Multigrade hydraulic fluid.

3. Under pump load, there is mixed statistical difference in the sound level (dB) produced between a Monograde and High VI Multigrade hydraulic fluid when comparing the pump load minus idle sound level (dB).

4. Under pump load, there is no statistical difference in the sound level (dB) produced between the Monograde at the start and at the end of the test.

1. A method of reducing noise generation in a hydraulic system, comprising:
contacting a hydraulic fluid comprising a polyalkyl(meth)acrylate polymer with a hydraulic system, to reduce the noise of said hydraulic system.

2. The method according to claim 1, wherein said hydraulic fluid has a VI of at least 130.

3. The method according to claim 1, wherein a vibration generated in said hydraulic system is reduced.

4. The method according to claim 1, wherein said hydraulic system comprises a pump, a motor or both.

5. The method according to claim 3, wherein a source of the vibration is fluid flow pressure pulsations, friction, or internal pump leakage.

6. The method according to claim 1, wherein said hydraulic fluid has a VI of at least 130 and radiates a lower level of noise compared to a monograde hydraulic fluid operating at the same temperature and pressure conditions.

7. The method according to claim 1, wherein said noise is a sum of fluid borne noise and structure borne noise.

8. The method according to claim 1, wherein said hydraulic fluid further comprises a base oil, and an anti-wear additive.

9. The method according to claim 2, wherein said hydraulic fluid having a viscosity index greater than 130 is utilized to reduce internal pump leakage/recycle, thereby reducing fluid borne and structure borne noise.

10. The method according to claim 1, wherein PAMA compounds solubilized as molecular coils dampen vibrational waves that are generated by the operation of the hydraulic system.

11. The method according to claim 1, wherein no silencer, insulation, or both is used in said hydraulic system.

12. The method according to claim 1, wherein the polyalkyl(meth)acrylate polymer comprises at least 40% by weight methacrylate repeating units.

13. The method according to claim 1, wherein the hydraulic fluid comprises 1-30% by weight polyalkyl(meth)acrylate polymer.

14. The method according to claim 1, wherein the polyalkyl(meth)acrylate polymer has a molecular weight in the range of 10000-200000 g/mol.

15. The method according to claim 1, wherein the polyalkyl(meth)acrylate polymer comprises C₉-C₂₄ (meth)acrylate repeating units and C₁-C₈ (meth)acrylate repeating units.

16. The method according to claim 1, wherein the polyalkyl(meth)acrylate polymer comprises repeating units derived from dispersing monomers.

17. The method according to claim 1, wherein the polyalkyl(meth)acrylate polymer comprises repeating units derived from styrene.

18. The method according to claim 1, wherein the polyalkyl(meth)acrylate polymer comprises repeating units derived from ethoxylated and/or hydroxylated methacrylate monomers.

19. The method according to claim 1, wherein the hydraulic fluid comprises an antioxidant, a corrosion inhibitor, a defoamer or mixtures thereof.

20. The method according to claim 1, wherein the hydraulic fluid comprises a mineral oil.

21. The method according to claim 1, wherein said hydraulic fluid comprises an oil from API Group I, II, or III.

22. The method according to claim 1, wherein the hydraulic fluid comprises at least one oil from API Group IV and V.

23. The method according to claim 1, wherein said hydraulic fluid comprises a synthetic base stock;
wherein the synthetic basestock comprises a poly-alpha olefin, a carboxylic ester a carboxylic diester, a polyol ester, phosphate ester, polyalkylene glycol or mixtures thereof.

24. The method according to claim 1, wherein the polyalkyl(meth)acrylate polymer is obtained by polymerizing a mixture of olefinically unsaturated monomers, said mixture comprising
a) 0-100 wt % based on the total weight of the ethylenically unsaturated monomers of one or more ethylenically unsaturated ester compounds of formula (I) 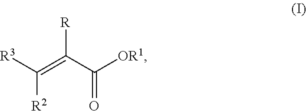
wherein
R is hydrogen or methyl,
R¹ means a linear or branched alkyl residue with 1-8 carbon atoms,
R² and R³ independently represent hydrogen or a group of the formula —COOR′, wherein R′ means hydrogen or a alkyl group with 1-8 carbon atoms,
b) 0-100 wt % based on the total weight of the ethylenically unsaturated monomers of one or more ethylenically unsaturated ester compounds of formula (II) 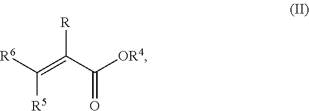
wherein
R is hydrogen or methyl,
R⁴ means a linear or branched alkyl residue with 9-16 carbon atoms,
R⁵ and R⁶ independently are hydrogen or a group of the formula —COOR″, wherein R″ means hydrogen or an alkyl group with 9-16 carbon atoms,
c) 0-80 wt % based on the total weight of the ethylenically unsaturated monomers of one or more ethylenically unsaturated ester compounds of formula (III) 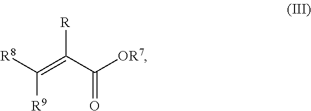
wherein
R is hydrogen or methyl,
R⁷ means a linear ox branched alkyl residue with 17-40 carbon atoms,
R⁸ and R⁹ independently are hydrogen or a group of the formula —COOR″′, wherein R″′ means hydrogen or an alkyl group with 17-40 carbon atoms, and
d) 0-50 wt % based on the total weight of the ethylenically unsaturated monomers comonomers,
wherein at least 50 wt % based on the total weight of the ethylenically unsaturated monomers are methacrylates.

25. The method according to claim 24, wherein the mixture of olefinically unsaturated monomers comprises 50 to 95% by weight of the component b).

26. The method according to claim 24, wherein the mixture of olefinically unsaturated monomers comprises 1 to 30% by weight of the component a).
